(19) United States
(12) Patent Application Publication
(10) Pub. No.: US 2003/0093572 A1
(43) Pub. Date: May 15, 2003

(54) Method and system for browser integration using a forwarding plug-in

(76) Inventors: Thorsten O. Laux, Santa Clara, CA (US); Ingrid Halama, Hamburg (DE); Mikhail Voitenko, Hamburg (DE)

Correspondence Address: SONNENSCHEIN NATH & ROSENTHAL, P.O. BOX 061080, WACKER DRIVE STATION, CHICAGO, IL, 60606-1080, US

(21) Appl. No.: 10/271,567

(22) Filed: Oct. 17, 2002

(30) Foreign Application Priority Data
Oct. 18, 2001 (EP) 01 124 297.1

(51) Int. Cl. G06F 15/16

(52) U.S. Cl. 709/250; 709/203

(57) ABSTRACT

Methods and systems in accordance with the present invention provide flexibility for use of plug-ins by implementing a forwarding plug-in. The forwarding plug-in forwards a user's or application's service request to the appropriate implementation plug-in for processing. In this manner, data files of the same data type, such as a MIME type, can be automatically processed and implemented by different plug-ins, thereby increasing flexibility and ease of use. As a result, different versions of data files of the same data type can be processed automatically without significant reworking of the system. The decision where to route the activation request may be made, for example, by a forwarding plug-in based on a user query via a graphical user input (“GUI”) or configuration data stored with the forwarding plug-in which determines which plug-in is to be used. The configuration data may indicate different implementation plug-ins to the forwarding plug-in for different users, computing environments, versions, system resources, or any other algorithm, criteria or reason.

### CROSS REFERENCE TO RELATED APPLICATION

This application is related to, and claims priority to, European Patent Application No. 01 124 297.1, filed on Oct. 18, 2001, commonly owned, and entitled “Method for Processing a Data File Using a Plug-In,” and which is hereby incorporated by reference herein in its entirety.

### BACKGROUND

1. Field of the Invention

The present invention generally relates to a method and system for processing a data file in a distributed environment. In particular, the present invention generally relates to browsers, plug-ins and the use of forwarding plug-ins.

2. Background Information

Data processing devices are used for a wide range of versatile applications, providing services to potentially large numbers of different users. The applications may range from editing of text documents or spreadsheet applications to complex software systems, for example, for computer aided design and manufacturing, purchasing, computer aided banking applications, entertainment applications, and numerous other application areas. Increasingly complex software applications are employed in the field of personal services, for example, for personal data organization and mobile communication applications such as mobile telephones or communications services and other services provided over computer networks, such as the Internet.

In any of the above-outlined examples, particularly in a distributed environment involving processing of information at different physical locations, a number of different applications or modules of an application may interact and cooperate to provide a particular service. Further, different applications or modules of an application may be executed and interact on a single data processing device to provide a particular service.

In these cases, it is important that compatibility between different applications or, modules of applications is provided. Further, it is important to provide different applications or modules of an application cooperating with one another with information on respective other applications or modules, in order to allow a correct addressing of calls or requests and to assure that the modules or applications communicate with the correct counterpart.

In many distributed systems, “browsers” are used to view and manipulate information. Commonly, a browser is a software application used to, for example, aid a user in locating, displaying and browsing through various types of data such as HyperText Markup Language (“HTML”) web pages. Many browsers can display text, graphics and multimedia information including sound and video, and many times a user using a browser may need to view, access or process a data file of a particular data type, such as a type of video file or audio file.

However, many browsers require “plug-ins” for accessing some types and formats of data. A plug-in is a hardware or software module that adds a specific feature or service to a larger system, and plug-ins typically allow browsers to access, process and display different types data, such as audio or video.

Various data files are typically classified in specific data file types. On large networks, such as the Internet, consistency in the data types, their names and formats helps many users interact with each other in a compatible manner. Designed by the Internet Engineering Task Force, one commonly used convention is Multipurpose Internet Mail Extensions (“MIME”) which is a specification for formatting non-ASCII messages so they can be sent over networks such as the Internet. MIME enables browsers to display and output files that are not in HTML format, and many browsers and e-mail applications support MIME which enables them to send and receive graphics, audio, and video files, for example, via the Internet mail system. MIME types typically identify a content type and allow a browser or server to select the type of viewer for the file. There are many predefined MIME types, such as GIF graphics files and PostScript files.

Generally, a browser uses one plug-in for a specific MIME type, meaning that any two files of the same MIME type that are requested to be processed are processed by the same plug-in. The browser may contain a registry of the correlation between plug-ins to MIME types. If a user wants to work with several versions of a browser plug-in simultaneously and all the versions are registered to the same MIME type, it depends on the browser implementation which plug-in version gets activated, but only one will be activated for that MIME type, typically the newest one.

This is a particular problem in distributed systems in which servers do most of the processing and the client functions are kept to a minimum. In such distributed environments, a client browser may request a server to process a data file of a given type, and a plug-in on the client streams the data file to the server for processing. Having no easy flexibility, the client always uses the same plug-in for that MIME type for processing. This is a problem in an environment where different server versions need different plug-in versions to work with. If a different version of the plug-in or different version of the processing application on the server is desired to process a data file of the same MIME type, the browser will automatically default to the one set for that specific MIME type, thereby having no flexibility. Additionally, there is the potential that if the client and server versions don't match, the application will not work.

For example, if a plug-in on a browser is registered for a specific data type, such as StarOffice™ documents from Sun Microsystems, Inc., and a StarOffice document is activated in the browser, that plug-in is used to process it. The plug-in contacts the corresponding server and streams the document to the server for further processing.

If a new version of the product, i.e., the server and the plug-in, is implemented, the new plug-in will also be registered for StarOffice documents, thereby creating an ambiguity because the previous version is also registered for that MIME type. In this case, there are two plug-ins and two servers both registered to process documents of the same MIME type. Typical systems will select the same plug-in for that MIME type every time, thereby depriving the user of the flexibility of using different plug-ins, and possibly different versions, for the same MIME type.

FIG. 1a depicts a block diagram representation of a related art system with a client 102 having a browser 104 and activating a plug-in 106. As shown in the figure, a user makes a service request to process a data file 108 of a given MIME type. When the browser 104 receives the request, it activates the plug-in (implementation plug-in 106) that corresponds to that MIME type. The plug-in 106 contacts the corresponding server 110 and streams the data file 108 to the service application 112 for processing.

FIG. 1b shows that when the same system as in FIG. 1a receives a request to process a file of the same MIME type, but being a different version, the same plug-in 106 is activated to stream the file to the server 116 for processing. This may pose a problem when another plug-in, such as implementation plug-in 114, exists that may be better for processing that specific file at that time. The user does not have the flexibility to conveniently use another plug-in 114 and its corresponding server 116. It is therefore desirable to overcome these and related problems.

### SUMMARY OF THE INVENTION

Methods and systems in accordance with the present invention provide flexibility for use of plug-ins by implementing a forwarding plug-in. The forwarding plug-in forwards a user's or application's service request to the appropriate implementation plug-in for processing. In this manner, data files of the same data type, such as a MIME type, can be automatically processed and implemented by different plug-ins, thereby increasing flexibility and ease of use. As a result, different versions of data files of the same data type can be processed automatically without significant reworking of the system. The decision where to route the activation request may be made by a forwarding plug-in, for example, based on a user query via a graphical user input (“GUI”) or configuration data accessible by the forwarding plug-in which determines which plug-in is to be used. The configuration data may indicate different implementation plug-ins to the forwarding plug-in for different users, computing environments, versions, system resources, or any other algorithm, criteria or reason.

In accordance with methods and systems consistent with the present invention, a method in a data processing system for processing a data file is provided wherein the data processing system has one or more forwarding plug-ins and a plurality of implementation plug-ins. The method comprises receiving a request to process a data file having a data file type, and activating one of the forwarding plug-ins based on the data file type. The method further comprises selecting, by the activated forwarding plug-in, one of the implementation plug-ins for processing the data file based on configuration data available to the activated forwarding plug-in, the configuration data specifying the one implementation plug-in for processing the data file.

In accordance with methods and systems consistent with the present invention, a data processing system for processing a data file using a forwarding plug-in is provided. The data processing system comprises a memory having program instructions, one or more forwarding plug-ins, and a plurality of implementation plug-ins. It further comprises a processor configured to execute the program instructions to receive a service request to process the data file having a data file type, activate one of the forwarding plug-ins based on the data file type, and select one of the implementation plug-ins for processing the data file based on configuration data available to the activated forwarding plug-in, the configuration data specifying one of the implementation plug-ins for processing the data file.

In accordance with methods and systems consistent with the present invention, a data processing system is provided for processing a data file system for processing a data file, wherein the data processing system has one or more forwarding plug-ins and a plurality of implementation plug-ins. The data processing system comprises means for receiving a request to process a data file having a data file type, and means for activating one of the forwarding plug-ins based on the data file type. The data processing system further comprises means for selecting, by the activated forwarding plug-in, one of the implementation plug-ins for processing the data file based on configuration data available to the activated forwarding plug-in, the configuration data specifying the one implementation plug-in for processing the data file.

### BRIEF DESCRIPTION OF THE DRAWINGS

The accompanying drawings, which are incorporated in and constitute a part of this specification, illustrate embodiments in accordance with the present invention and, together with the description, serve to explain the advantages and principles consistent with the present invention.

FIGS. 1a and 1b depict block diagrams of a related art system processing different versions of a data file of the same data type with a browser and plug-in.

FIGS. 2a and 2b show block diagrams of a system for processing different versions of data files of the same data type with a server, a client browser, a forwarding plug-in, and implementation plug-ins in accordance with method and systems consistent with the present invention.

FIG. 3 depicts a flowchart of a method for using a forwarding plug-in in a distributed system in accordance with method and systems with the present invention.

FIG. 4 illustrates a block diagram of a browser using a forwarding plug-in on a client in accordance with method and systems consistent with the present invention.

FIG. 5 is a flowchart showing a method for using a forwarding plug-in on a client in accordance with method and systems consistent with the present invention.

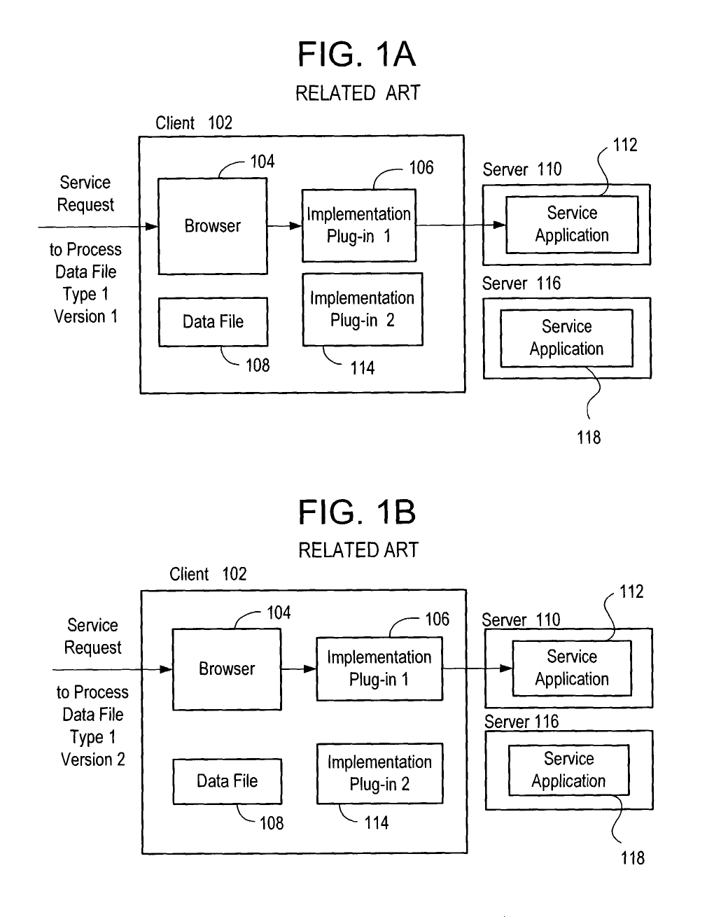

### DETAILED DESCRIPTION

Methods and systems consistent with the present invention provide flexibility for use of plug-ins by implementing a forwarding plug-in. The forwarding plug-in forwards a user's or application's service request to the appropriate implementation plug-in for processing. In this manner, data files of the same data type, such as a MIME type, can be automatically processed and implemented by different plug-ins, thereby increasing flexibility and ease of use. As a result, different versions of data files of the same data type can be processed automatically without significant reworking of the system. The decision where to route the activation request may be made by a forwarding plug-in, for example, based on a user query via a graphical user input (“GUI”) or configuration data accessible by the forwarding plug-in which determines which plug-in is to be used. The configuration data may indicate different implementation plug-ins to the forwarding plug-in for different users, computing environments, versions, system resources, or any other algorithm, criteria or reason.

One advantage is the ability to use several versions of the same browser plug-in simultaneously on a client and to provide an easily configurable way of selecting the desired version. Another advantage is that it is independent of the plug-in API used underneath. For example, such a forwarding plug-in can forward requests to different types of browser plug-ins, e.g., Mozilla plug-ins, Netscape plug-ins, ActiveX Controls in Internet Explorer.

In some embodiments in accordance with the present invention, the forwarding plug-in forwards the service request to a server, which then sends the request to the appropriate implementing plug-in, for example, back on the client. In this case, the server triggers the actual implementation plug-in to use, but the forwarding plug-in selects the server which in turn selects the implementation plug-in.

A forwarding plug-in may be registered for each data file type, such as a MIME type, and, in one embodiment, is registered for all MIME types it is managing. The forwarding plug-in is configured to determine to which implementation plug-in requests are to be forwarded. The forwarding plug-in can be registered to known file types, e.g., StarOffice, and can forward activation requests to implementation plug-ins that may be specific for different versions, etc. In one embodiment in accordance with the present invention, the implementation plug-ins are each registered to unique versions of an application.

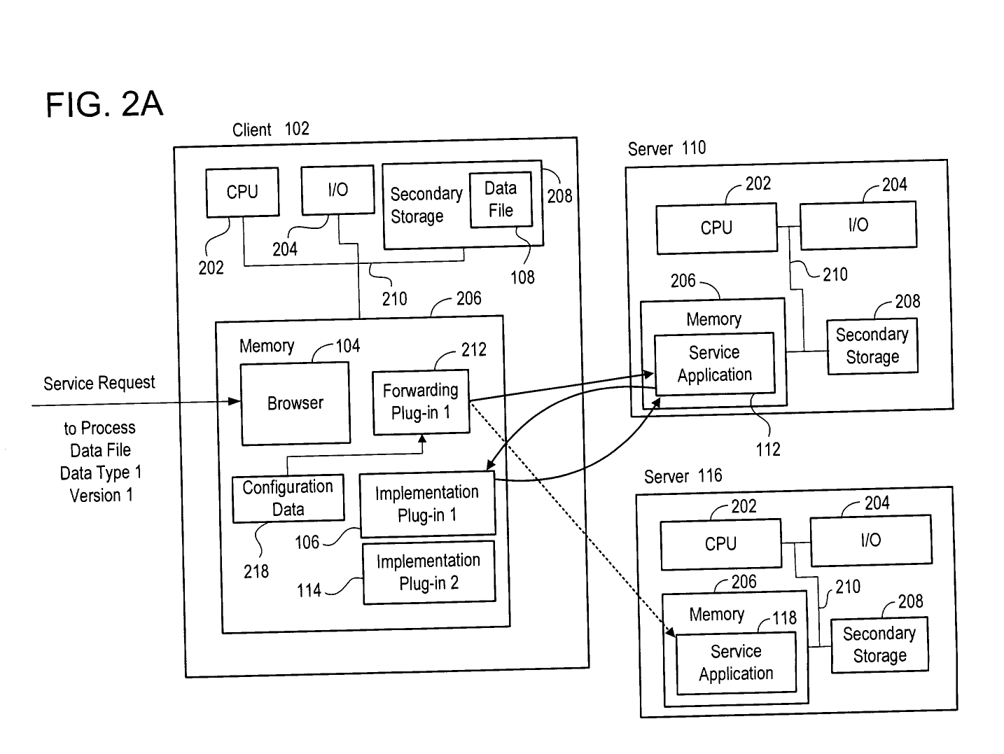

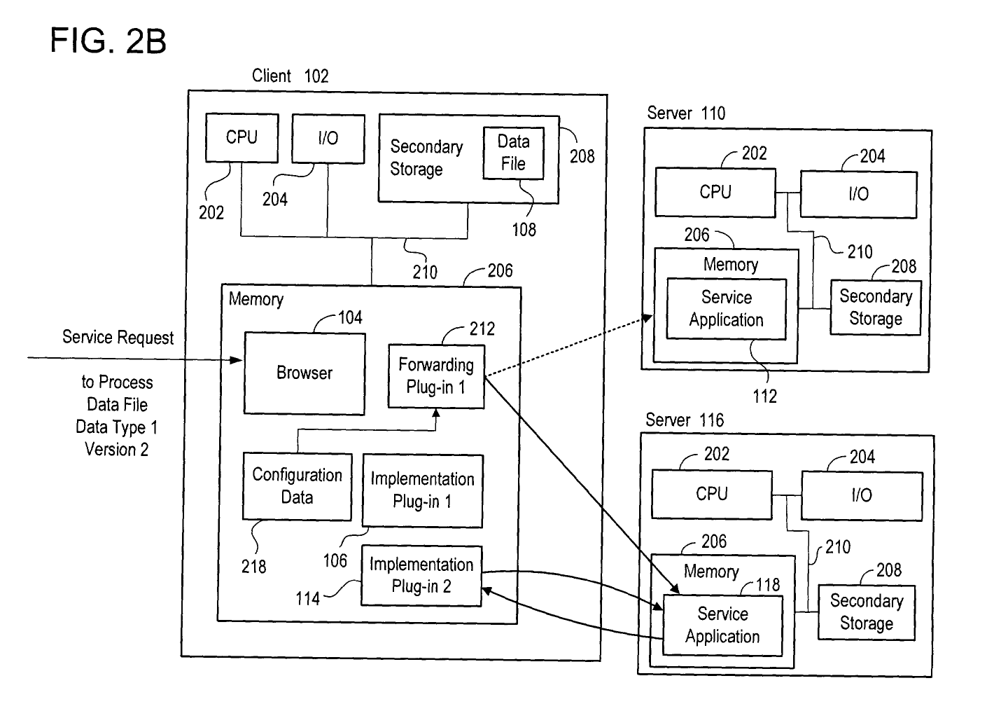

FIGS. 2a-2b further depict a block diagram of an exemplary data processing system suitable for practicing methods and implementing systems consistent with the present invention. FIG. 2a depicts a client computer 102 and server computers 110 and 116, and either computer may represent any kind of data processing device, such as a general purpose data processing device, a personal computer, a plurality of interconnected data processing devices, a mobile computing device, a personal data organizer, a mobile communication device including mobile telephones or other similar devices. The client 102 and servers 110 and 116 may represent computers in a distributed computing environment, such as Sun One Webtop developed by Sun Microsystems, Inc.

A client 102 includes a central processing unit 202 (“CPU”), and input-output (“I/O”) unit 204, a memory 206 such as a random access memory (“RAM”) or other dynamic storage device for storing information and instructions to be executed by the CPU. The client 102 also includes a secondary storage device 208, such as a magnetic disk or optical disk that may communicate with each other via a bus 210 or other communication mechanism.

Although aspects of methods and systems consistent with the present invention are described as being stored in memory, one having skill in the art will appreciate that all or part of methods and systems consistent with the present invention may be stored on or read from other computer-readable media, such as secondary storage devices, like hard disks, floppy disks, and CD-ROM; a carrier wave received from a network such as the Internet; or other forms of ROM or RAM either currently known or later developed. Further, although specific components of the data processing system are described, one skilled in the art will appreciate that a data processing system suitable for use with methods, systems, and articles of manufacture consistent with the present invention may contain additional or different components.

The client 102 may further include input devices such as a keyboard, and mouse or speech processor (not shown) and a display device (not shown) such as a cathode ray tube (“CRT”), for displaying information to a user. The client 102 may include a human user or may include a user agent. The term “user” as used herein refers to a human user, software, hardware or any other entity using the system.

As shown, the memory 206 in the client 102 includes a browser 104, a forwarding plug-in 212, implementation plug-ins 106 and 114, and configuration data 218. A browser application 104 is typically any program or group of application programs allowing convenient browsing through information or data available in distributed environments, such as the Internet or any other network including local area networks. A browser application 104 generally allows viewing, downloading of data and transmission of data between data processing devices. The browser 104 may also be other kinds of applications.

Although shown in the secondary storage 208, the data file 108 may also be included in the memory 206 or elsewhere. The data file 108 may be any data file, such as a text document, video file, audio file, multimedia file, etc. The data file 108 may have any other format or type, may include instructions for triggering execution of a certain functionality, and may include parameters to be processed or have other aspects.

The configuration data 218 in the memory 206 may be any data available to the forwarding plug-in 212 to determine which implementation plug-in 106 or 114 is to be used. The configuration data 218 may be stored anywhere such as in the memory 206 or secondary storage 208. Further, the configuration data 218 could be stored at an external location, for example, such as on a data storage unit accessible by the forwarding plug-in 212, browser 104 or client 102, and such a data storage unit could be accessible through a communication network.

An implementation plug-in 106 may be a piece of software to be used in connection with a larger application program for providing a specific additional service, such as special text editing, graphical viewing, special spreadsheet applications, etc. A plug-in 106 may enhance a functionality of a browser application 104 for browsing through information available on a network of computing devices. Accordingly, a plug-in 106 may generally be a software module which may be added to any kind of larger software application, such as a browser application 104, to add a defined functionality. Further, a plug-in 106 may be added to the larger software application generally at any desired time, provided that the larger software application is equipped to receive and integrate the plug-in. The code for the plug-in 106 may be obtained from any source, such as over a computer network, a data storage medium or similar component. Alternatively, a plug-in 106 may also be a piece of hardware adding functionality to an application or larger hardware structure.

Some examples of plug-ins 106 may include applications for displaying text information, such as Acrobat reader for displaying files in the PDF format, applications for displaying images in the GIF format, TIFF format, JPEG format, etc. Examples also include Moving Pictures Expert Group (“MPEG”) players for playback of videos in the MPEG format, wave-audio players for playback of digital sound files, e.g., WAV format, MP3 format. Further examples are applications enabling user interaction for drawing and editing operations, JAVA applets, and software applications for remote visualization, such as the Remote Visualization Process protocol (“RVP”). Another example of plug-ins 106 are runtime environment component services to ensure convenient access from a first computer system to resources available at a second computer system. An example of a runtime environment component service is disclosed in the European patent application EP01100136.9, entitled “Runtime Environment Component Services” and filed Jan. 15, 2001, which is incorporated herein by reference.

In general, an implementation plug-in 106 processes or handles a data file 108 specified in the service request in a defined way. While the handling of the processing of the data file 108 by different implementation plug-ins 106 may be fundamentally different, it is also possible that different implementation plug-ins carry out substantially the same functionality in certain variations. For example, it is possible that a group of implementation plug-ins 106 constitute individual modifications of a basic plug-in, such as different release versions of the plug-in, or versions or instances of a plug-in associated with different versions or instances of operating applications involved in serving the service request.

Additionally, an implementation plug-in 106 itself may not necessarily be a single unit, but may be realized in different sub-modules, which may even be arranged in a distributed environment. Thus, an implementation plug-in 106 may supervise the processing of the data file 108 by placing calls to further sub-modules.

Although only one browser 104 and forwarding plug-in 212 are shown on the FIGS. 2a-2b, any number of browsers, forwarding plug-ins and implementation plug-ins 106 may be used. Additionally, although shown on the client 102 in the memory 206, these components may reside elsewhere, such as in the secondary storage 208, or on another computer, such as another server 110. Furthermore, these components may be hardware or software whereas embodiments in accordance with the present invention are not limited to any specific combination of hardware and/or software.

FIGS. 2a-2b also depict a server 110 that includes a CPU 202, an I/O unit 204, a memory 206 having a server application 112, and a secondary storage device 208 that communicate with each other via a bus 210. The server application 112 may also reside elsewhere, such a secondary storage 208. The server application 112 may be any application, e.g., a text processing application, a graphics application, a spreadsheet application, an application of a mobile computing device including a mobile telephone, a banking application, and entertainment application, or any other application. The server application 112 may be an application implementing StarOffice or related products such as Sun One Webtop. The server 110 may also have many of the components mentioned in conjunction with the client 102.

The client 102 and server 110 may communicate directly or over networks, and may communicate via wired and/or wireless connections or any other method of communication. Communication may be done through any communication protocol, including known and yet to be developed communication protocols. The network may comprise many more clients 102 and servers 110 and 116 than those shown on the figure, and the client and server may also have additional or different components than those shown.

FIG. 2a illustrates, in addition to the components of a data processing system in accordance with the present invention, the processing of a user's service request to processing data file 108 using a plug-in 106. As an overview, a user's request is received by the browser 104, which is sent to the forwarding plug-in, which in turn selects a server (in this case, server 110, although it could have selected server 116) and sends the request. The server 110 then activates the appropriate implementation plug-in (in the case, implementation plug-in 106) which streams the data file 108 back to the server for processing. The selection of the server 110, and in turn, the implementation plug-in 106 was made during execution by the forwarding plug-in 212 based on current configuration data 218 or user selection.

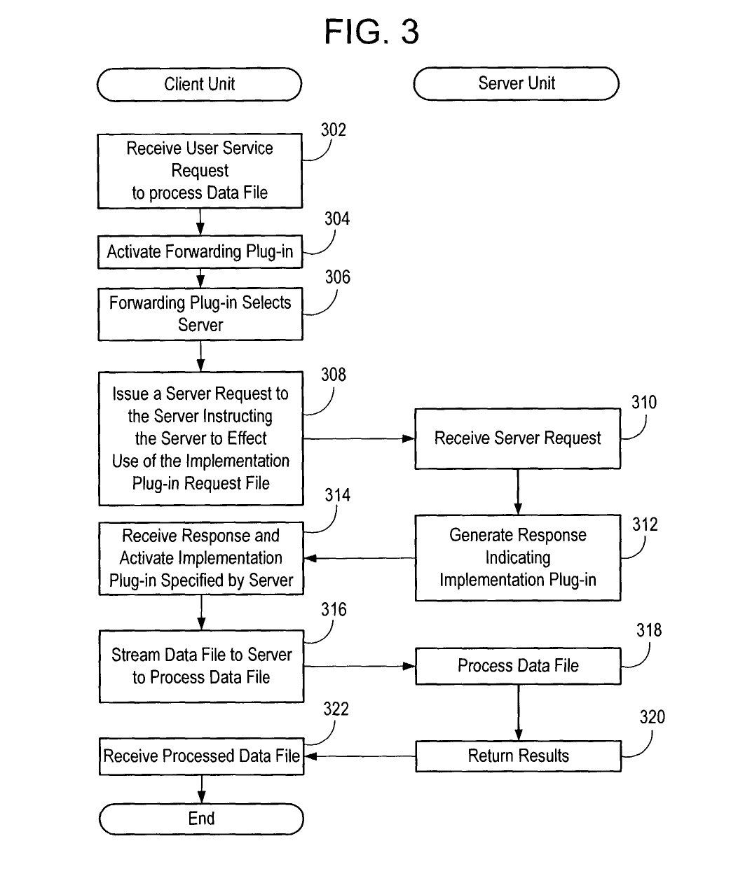

FIG. 3 is a flowchart illustrating steps of a method for using a forwarding plug-in in a distributed system in accordance with the present invention, and will be discussed in conjunction with FIG. 2a. First, the client 102 receives a user's service request to process a data file 108 having a data type (step 302). The service request may include an instruction to process a data file 108, using any processing operation, such as editing the data file, processing information included in the data file, transferring the data file, generating screen elements on a display, etc. The service request could be issued by any application providing a certain service or functionality, located either within the client 102, or could be located externally, in which case the service request could be received over a communication link.

The service request may be a click on a reference in a HTML page, and the browser 104 receives an HTML request for the requested data file 108. It may also be a double click on a document that is registered to be opened, and the browser 104 will activate the document. Further, a user may drag and drop a document to the browser 104, and if there is a plug-in 106 registered for the data file 108, it will be activated by the browser. Whereas the service request may specify a data file 108 with a data file type for further specifying the format of the data file, the data file type may, for example, be specified by a file extension or other indicator and could show that the data file has a particular format, content, or any other characteristics.

The service request may be a request to activate or process a data file 108 having a MIME type, e.g, StarOffice. The data file 108 may also have more identification, such as a version, e.g., version 1 as shown on the FIG. 2a. Different data files 108 having different versions may have the same MIME type, but in accordance with methods and systems in consistent with the present invention, may ultimately be processed by different implementation plug-ins.

When the browser 104 receives the service request, it determines which forwarding plug-in 212 to activate based on the data type, i.e., MIME type, activates the forwarding plug-in, and sends the request to the forwarding plug-in (step 304). As previously noted, in one embodiment, all forwarding plug-ins 212 are registered to one or more MIME types. For example, if the service request is to process a StarOffice document, the browser 104 sends the request to the forwarding plug-in 212 registered for StarOffice documents.

If there is only one forwarding plug-in 212 available, it may not be necessary to use a selection process to determine the forwarding plug-in. Otherwise, the selection may involve a look-up operation in a look-up table (not shown) specifying all available data file types and identifying forwarding plug-ins 212 registered to the respective data file types. The look-up table could be stored locally on the client 102 or could be accessed at a remote location.

The forwarding plug-in 212 then selects a server 110 to process the data file 108 based on the configuration data 218 or user input (step 306). In another embodiment without servers discussed below, the forwarding plug-in 212 selects an implementation plug-in 106 to process the file without involving a server, and even in embodiments using servers, the forwarding plug-in may select the implementation plug-in directly, or through other components. The user may be prompted during execution by a GUI to select an implementation plug-in or server to process the data file 108. Alternatively, the forwarding plug-in 212 may determine which server to use based on configuration data 218. The configuration data 218 may indicate different implementation plug-ins based on different user identifications, computing environments, source of service request, operating systems, versions, system resources, user preferences determined at any time, or any other algorithm, criteria or reason. In the embodiment shown on the figure, the forwarding plug-in 212 selects server 110, although it could have selected server 116 (as indicated by the dashed line) if indicated by the user or configuration data 218.

By providing this forwarding capability, it becomes possible to provide for different processing options of data files 108 having one specified data file type. In systems without the forwarding functionality of the forwarding plug-in 212, a selection of different implementation plug-ins for different processing operations may not be possible. Instead, based on the data file type indicated in the service request, the same plug-in for performing the requested processing operations would always be selected, in the absence of further selection information.

The forwarding plug-in 212 then establishes communication with the server 110 instructing the server to initiate processing of the data file 108 (step 308). Although arrows on the figures show a direct connection from the server to both forwarding and implementation plug-ins, in some embodiments in accordance with the present invention, communications between the servers and the plug-ins are actually routed through the browser 104 or other communications applications. In one embodiment, the forwarding plug-in 212 initiates the browser 104 to send to the server 110 an HTTP request with a link to the requested data file 108 or stream representing the data file, and any appropriate parameters. In another embodiment, the forwarding plug-in 212 or browser 104 may also write and send a request file including information identifying the implementation module and may generate an instruction to read the request file for effecting use of the implementation plug-in 106. In this case, an application program cooperating with the implementation plug-in 106 could be instructed to read the data file 108 and accordingly proceed to use the implementation plug-in for processing the data file 108.

The server 110 receives the request (step 310), processes it, and generates a response indicating the appropriate implementation plug-in 106 to use (step 312). In doing so, the server 110 accounts for provided parameters, authenticates the user and generates an HTML page that lets the browser 104 activate the implementation plug-in 106. The HTML page provides an entry that activates the implementation plug-in 106 with some parameters, and document and authentication information.

The client 102 receives the response from the server 110 and activates the implementation plug-in 106 specified by the server (step 314). The implementation plug-in 106 processes the file and streams the data file 108 to the server 110 for further processing (step 316). In one embodiment, the implementation plug-in 106 uses a separate communication application to stream the data file 108 to the server 110. The server 110 receives the data file 108 from the implementation plug-in 106, processes the data file (step 318) and returns the results (step 320). The client 102 receives the results of the processed data file 108 from the server 110 (step 322) and reports it to the user.

FIG. 2b illustrates that, if the configuration data 218 is configured to indicate a different server 116 for a different version of the data file 108, the same data processing system can automatically implement the use of a different server and implementation plug-in, i.e., server 116 and implementation plug-in 114, for a data file of the same MIME type as the data file in FIG. 2a, but being a different version. In this example, the client 102 receives a service request from a user to process a data file 108 having the same data type, i.e., MIME type, as the data file in FIG. 2a. However, this data file 108 is of a different version, possibly an older version, for example.

As before, the browser 104 receives the user's request, and activates the same forwarding plug-in 212 because the MIME type is the same. In this example, due to the configuration of the configuration data 218, the forwarding plug-in 212 selects a different server 116, and in turn a different implementation plug-in 114, because the version of the data file 108 is different. As indicated by the dashed line, the forwarding plug-in 212 could have selected the same server 110 (or any other server) as in FIG. 2a. The process from this point is the same as in FIG. 2a and FIG. 3 (starting from step 308). As can be seen from FIGS. 2a and 2b, different implementation plug-ins can be determined on-the-fly and used for data files 108 having the same data types.

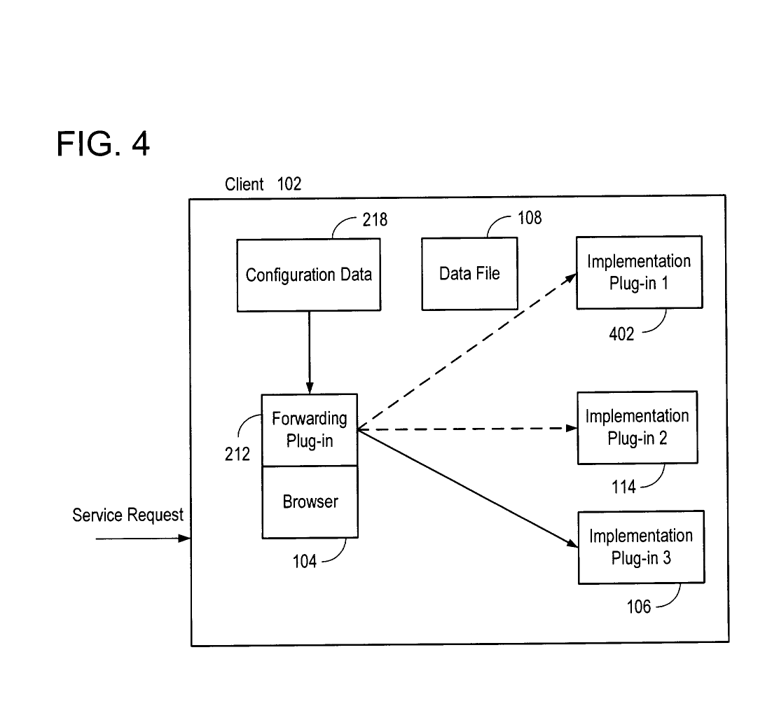

FIG. 4 illustrates a browser 104 using a forwarding plug-in 212 on a client 102 without a server in accordance with the present invention. As mentioned, although many distributed environments such as Sun One Webtop use servers, a server is not required. Operation is similar to the server embodiments, but the forwarding plug-in 212 selects the implementation plug-in 106 directly or via another component.

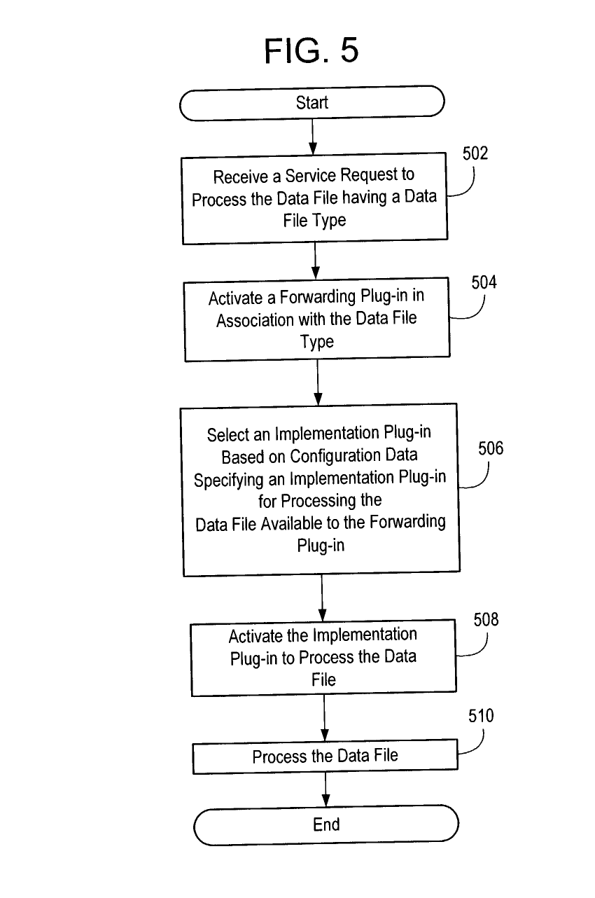

FIG. 5 shows a method for using a forwarding plug-in 212 on a client 102 without a server in accordance with the present invention, and will be discussed in conjunction with FIG. 4. First, the client 102 receives a user's service request to process a data file 108 having a data type (step 502). When the browser 104 receives the service request, it determines which forwarding plug-in 212 to activate based on the data type, i.e., MIME type, activates the forwarding plug-in, and sends the request to the forwarding plug-in (step 504).

The forwarding plug-in 212 then selects an implementation plug-in 106 to process the data file 108 based on the configuration data 218 or user input (step 506). The user may be prompted during execution by a GUI to select an implementation plug-in 106, 114 or 402 to process the data file 108. Alternatively, the forwarding plug-in 212 may determine which implementation plug-in 106, 114 or 402 to use based on configuration data 218. Although, in this example, implementation plug-in 106 was selected, as indicated by the dashed arrows, other implementation plug-ins, e.g., 114 or 402, could have been selected.

Additionally, to facilitate an activation of the selected implementation plug-in, each implementation plug-in could also be registered to a data file sub-type. A data file sub-type could define a sub-format of the format of the data file 108, such as a format according to a particular release version or modification of the data file format. The data file sub-type may be used to uniquely identify one of the implementation plug-ins. Further, the data file sub-type may be used upon invoking or activating the implementation plug-in, for example, when the implementation plug-in is activated by a further application program involved in handling the data file 108. In this case, the application program involved in handling the data file 108 could issue a request including the data file sub-type and optionally the data file or parts thereof, leading to a selection of the implementation plug-in associated with the data file sub-type.

The forwarding plug-in 212 activates the implementation plug-in 106 (step 508) which processes the data file 108 (step 510). The implementation plug-in 106 selected for processing the data file 108 may retrieve the data file itself or, alternatively, the forwarding plug-in 212 may instruct an application cooperating with the implementation plug-in to transmit the data file or parts thereof to the implementation plug-in. The results may be returned to the user, for example, via the browser 104. In this embodiment, server processing is not necessary, and the forwarding plug-in 212 selected the implementation plug-in 106 on the client 102.

Other embodiments of the invention will be apparent to those skilled in the art from consideration of the specification and practice of the invention disclosed herein. Furthermore embodiments of the present invention may be implemented by computer programs that may be stored on computer-readable media. It is intended that the specification and examples be considered as exemplary, with a true scope and spirit of the invention being indicated by the following claims.

What is claimed is:

1. A method in a data processing system for processing a data file, the data processing system having one or more forwarding plug-ins and a plurality of implementation plug-ins, comprising:
receiving a request to process a data file having a data file type;
activating one of the forwarding plug-ins based on the data file type; and
selecting, by the activated forwarding plug-in, one of the implementation plug-ins for processing the data file based on configuration data available to the activated forwarding plug-in, the configuration data specifying the one implementation plug-in for processing the data file.

2. The method of claim 1, wherein the steps are performed by a browser.

3. The method of claim 1, further comprising:
initiating processing of the data file by the selected implementation plug-in.

4. The method of claim 1, further comprising:
sending the data file to the selected implementation plug-in.

5. The method of claim 1, wherein the activated forwarding plug-in resides on a client, and the method further comprises:
sending a request to a server instructing the server to initiate use of the selected implementation plug-in.

6. The method of claim 5, wherein the server request specifies a data file subtype.

7. The method of claim 1, wherein the activated forwarding plug-in writes a request file including information identifying the selected implementation plug-in and generates an instruction to read the request file for initiating use of the selected implementation plug-in.

8. The method of claim 1, wherein the activated forwarding plug-in is registered to a data file type and the method further comprises:
selecting the forwarding plug-in from the plurality of forwarding plug-ins based on the data file type.

9. The method of claim 1, wherein the selected implementation plug-in is registered to a data file sub-type, and wherein the configuration data link the data file type and the data file sub-type.

10. The method of claim 1, wherein the data file type is a MIME type.

11. The method of claim 1, wherein the configuration data specify an implementation plug-in based on at least one of: a computing environment, a source of the service request; and a user preference.

12. The method of claim 1, wherein the configuration data are generated during runtime.

13. The method of claim 5, wherein a client includes a plurality of client operating applications, each of the client operating applications cooperating with
a server operating application located on a server; and different implementation plug-ins are associated with different pairs of cooperating client and server operating applications.

14. A method in a data processing system having a browser, one or more forwarding plug-ins, and a plurality of implementation plug-ins, the method comprising:
receiving, by the browser, a request to process a data file having a data file type;
sending the request to one of the forwarding plug-ins based on the data file type;
determining, by the one forwarding plug-in, one of the implementation plug-ins to process the data file according to configuration data specifying the one implementation plug-in for processing the data file; and
activating the determined implementation plug-in to process the data file.

15. The method of claim 14, further including the step of:
processing the data file by the determined implementation plug-in.

16. A method in a data processing system for processing a data file, the data processing system having one or more servers, a browser, one or more forwarding plug-ins, and a plurality of implementation plug-ins, the method comprising:
receiving, by the browser, a request to process a data file having a data type;
activating one of the forwarding plug-ins based on the data type;
selecting, by the activated forwarding plug-in, a server to process the data file based on configuration data available to the activated forwarding plug-in;
sending a server request to the selected server by the activated forwarding plug-in;
receiving the server request by the selected server;
determining one of the implementation plug-ins to activate based on the received server request;
activating the determined implementation plug-in by the selected server; and
processing the data file by the activated implementation plug-in in response to the activation by the selected server.

17. A data processing system for processing a data file using a forwarding plug-in, comprising:
a memory having program instructions, one or more forwarding plug-ins, and a plurality of implementation plug-ins; and
a processor configured to execute the program instructions to receive a service request to process the data file having a data file type, activate one of the forwarding plug-ins based on the data file type, and select one of the implementation plug-ins for processing the data file based on configuration data available to the activated forwarding plug-in, the configuration data specifying one of the implementation plug-ins for processing the data file.

18. A data processing system comprising:
a memory having program instructions comprising a forwarding plug-in configured to receive an indication of a data file having a data type, determine an implementation plug-in to process the date file, and initiate activation of the determined implementation plug-in to process the data file; and
a processor for running the forwarding plug-in.

19. The data processing system of claim 18, wherein the memory further comprises:
an implementation plug-in selected by the forwarding plug-in and configured to receive and process the data file.

20. The data processing system of claim 18, wherein a browser comprises the program instructions.

21. A data processing system for processing a data file, comprising:
a browser for receiving a request to process a data file having a data file type and activating a forwarding plug-in based on the data file type;
configuration data for specifying an implementation plug-in to activate;
a forwarding plug-in for determining an implementation plug-in to activate based on the configuration data and the requested data file; and
an implementation plug-in selected by the forwarding plug-in for processing the data file.

22. A computer-readable medium containing instructions for controlling a data processing system having one or more forwarding plug-ins and a plurality of implementation plug-ins to perform a method for processing a data file comprising the steps of:
receiving a request to process a data file having a data file type;
activating one of the forwarding plug-ins based on the data file type; and
selecting, by the activated forwarding plug-in, one of the implementation plug-ins for processing the data file based on configuration data available to the activated forwarding plug-in, the configuration data specifying the one implementation plug-in for processing the data file.

23. The computer-readable medium of claim 22, wherein the method further comprises:
initiating processing of the data file by the selected implementation plug-in.

24. The computer-readable medium of claim 22, wherein the method further comprises:
sending the data file to the selected implementation plug-in.

25. The computer-readable medium of claim 22, wherein the activated forwarding plug-in resides on a client, and the method further comprises:
sending a request to a server instructing the server to initiate use of the selected implementation plug-in.

26. The computer-readable medium of claim 25, wherein the server request specifies a data file subtype.

27. The computer-readable medium of claim 22, wherein the activated forwarding plug-in writes a request file including information identifying the selected implementation plug-in and generates an instruction to read the request file for initiating use of the selected implementation plug-in.

28. The computer-readable medium of claim 22, wherein the activated forwarding plug-in is registered to a data file type, and the method further comprises:
selecting the forwarding plug-in from the plurality of forwarding plug-ins based on the data file type.

29. The computer-readable medium of claim 22, wherein the selected implementation plug-in is registered to a data file sub-type, and wherein the configuration data link the data file type and the data file sub-type.

30. The computer-readable medium of claim 22, wherein the data file type is a MIME type.

31. The computer-readable medium of claim 22, wherein the configuration data specify an implementation plug-in based on at least one of: a computing environment, a source of the service request; and a user preference.

32. The computer-readable medium of claim 22, wherein the configuration data are generated during runtime.

33. The computer-readable medium of claim 25, wherein a client includes a plurality of client operating applications, each of the client operating applications cooperating with a server operating application located on a server; and different implementation plug-ins are associated with different pairs of cooperating client and server operating applications.

34. A data processing system for processing a data file system for processing a data file, the data processing system having one or more forwarding plug-ins and a plurality of implementation plug-ins, comprising:
means for receiving a request to process a data file having a data file type;
means for activating one of the forwarding plug-ins based on the data file type; and
means for selecting, by the activated forwarding plug-in, one of the implementation plug-ins for processing the data file based on configuration data available to the activated forwarding plug-in, the configuration data specifying the one implementation plug-in for processing the data file.
